(19) United States
(12) Patent Application Publication
(10) Pub. No.: US 2009/0061509 A1
(43) Pub. Date: Mar. 5, 2009

(54) TREATMENT SYSTEM OF HIGH CONCENTRATION ORGANIC SEWAGE

(75) Inventor: Qingmei LI, Beijing (CN)

Correspondence Address: YING CHEN;Chen Yoshimura LLP, 255 S. GRAND AVE., # 215, LOS ANGELES, CA, 90012, US

(73) Assignee: BEIJING NENGTUO HIGH TECHNOLOGY CO., LTD, Beijing (CN)

(21) Appl. No.: 11/963,985

(22) Filed: Dec. 24, 2007

(30) Foreign Application Priority Data
Aug. 27, 2007 (CN) 200710120789.4

(51) Int. Cl. C02F 9/14

(52) U.S. Cl. 435/293.1

(57) ABSTRACT

The present invention relates to a treatment system of high concentration organic sewage treatment. The system mainly comprises a chemical settling device, an anoxic biochemical treatment fluidized bed, an anaerobic biochemical treatment fluidized bed and an aerobic biochemical treatment fluidized bed. The said primary filter device, chemical settling device, anoxic biochemical treatment fluidized bed, anaerobic biochemical treatment fluidized bed and aerobic biochemical treatment fluidized bed are connected in sequence. The said primary filter device is composed of several filter modules. The said chemical settling device is composed of several chemical settling units. The said anoxic biochemical treatment fluidized bed unit is equipped with several anoxic biochemical treatment modules. The said anaerobic biochemical treatment fluidized bed is equipped with several anaerobic biochemical treatment modules, and the said aerobic biochemical treatment fluidized bed is equipped with several aerobic biochemical treatment modules. The system is suitable to treat high concentration organic sewage of small scale, having good treatment effect, compact structure, small land used. Therefore, it is suitable to treat organic sewage in organic chemistry factories, pharmaceutical factories, tanneries and other places.

### TECHNICAL FIELD

The present invention relates to a treatment system of high concentration organic sewage.

### BACKGROUND

Organic sewage is mostly produced in chemical industry, pharmaceutical industry, fertilizer, food processing, etc. Main pollutants of the sewage are biochemical oxygen demand (“BOD”) and chemical oxygen demand (“COD”). Ii is difficult for people to treat high concentration organic pollutants, and usually huge treatment system is needed to treat effectively. However, it is obviously unsuitable to build such huge treatment system for pollution sources of small scale. Therefore, it is necessary to develop a kind of treatment system with both simple construction and good effect, therefore it is convenient to install, maintain and construct the system.

### SUMMARY

To overcome the said defect of the existing technology, it is provided a treatment system of high concentration organic sewage in the present invention, which is suitable to treat high concentration organic sewage of small scale. The system has good treatment effect and compact structure, for installing and maintaining, conveniently and flexibly, with small land used.

To achieve above purpose, the technical solution of the present invention is that: a treatment system of high concentration organic sewage mainly comprises a primary filter device, a chemical settling device, an anoxic biochemical treatment fluidized bed, an anaerobic biochemical treatment fluidized bed and an aerobic biochemical treatment fluidized bed. The said primary filter device, chemical settling device, anoxic biochemical treatment fluidized bed, anaerobic biochemical treatment fluidized bed and aerobic biochemical treatment fluidized bed are connected in sequence. The said primary filter device is composed of several filter modules. The said chemical settling device is composed of several chemical settling units. The said anoxic biochemical treatment fluidized bed unit is equipped with several anoxic biochemical treatment modules. The said anaerobic biochemical treatment fluidized bed is equipped with several anaerobic biochemical treatment modules. The said aerobic biochemical treatment fluidized bed is equipped with several aerobic biochemical treatment modules.

Since the whole treatment process of the present invention is reasonable, firstly, BOD/COD being greatly decreased by chemical settling, and then both BOD and COD with high concentration being removed by adopting anoxic/anaerobic/aerobic treatment route, it is suitable to treat high concentration organic sewage and has good treatment effect. Since the present invention achieves modularization of the treatment system, the treatment modules can be increased or decreased depending on needs and parallel series can be carried through flexibly between each module to form different flow patterns, therefore the time of every treatment process is guaranteed reasonably. The modularization design is beneficial to manufacture and process the equipment and decrease the manufacturing cost. The modularization design is convenient for construction and maintenance; further the expenses of investment and maintenance are decreased. The organic sewage treated by the system of the present invention can reduce the pollution level greatly. The treated sewage can be merged into the sewage of low pollution level for further treatment. When necessary, by enhancing purification efficiency of the aerobic fluidized bed and filtrating the effluent, the treated sewage can reach the reclaimed water reuse standard directly, and can be used as industrial circulating water, landscape water or irrigating water, etc. This achieves the recycling use of water without needing other diluted water source, matching reservoirs or building centralized water treatment plants with expensive investment and large occupation of land, also corresponding diversion and drainage pipeline system is omitted. The treatment scheme of unit style has the property of wide application, mobility and flexibility for installation, and can adapt to continuously changing situation of sewage discharge and continuously produced sewage source.

### BRIEF DESCRIPTION OF THE DRAWINGS

The accompanying drawings, which are incorporated in and constitute a part of specification, illustrate an exemplary embodiment of the present invention and, together with the general description given above and the detailed description of the preferred embodiment given below, serve to explain the principles of the present invention.

FIG. 1 is a structure schematic diagram of the present invention.

### DETAILED DESCRIPTION

While the claims are not limited to the illustrated embodiments, an appreciation of various aspects of the present invention is best gained through a discussion of various examples thereof. Referring now to the drawings, illustrative embodiments will be described in detail. Although the drawings represent the embodiments, the drawings are not necessarily to scale and certain features may be exaggerated to better illustrate and explain an innovative aspect of an embodiment. Further, the embodiments described herein are not intended to be exhaustive or otherwise limiting or restricting to the precise form and configuration shown in the drawings and disclosed in the following detailed description.

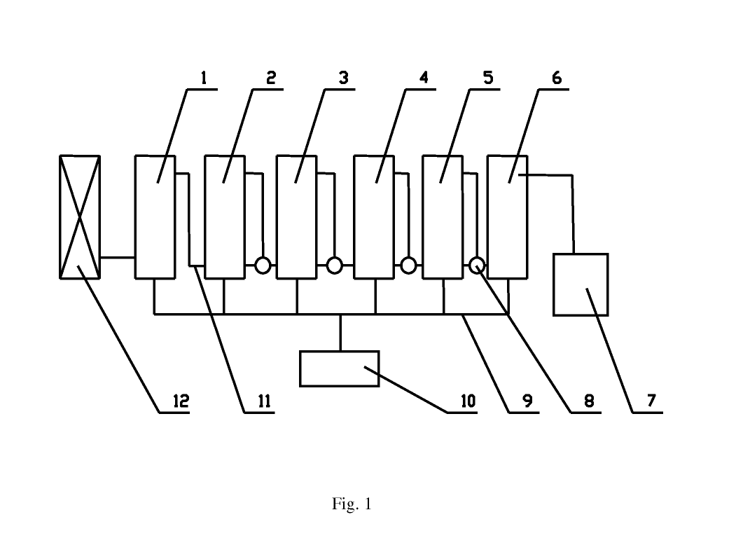

With reference to FIG. 1, it is provided a treatment system of high concentration organic sewage, which mainly comprises a chemical settling device 1, an anoxic biochemical treatment fluidized bed 2, an anaerobic biochemical treatment fluidized bed 3 and an aerobic biochemical treatment fluidized bed 4. The said primary filter device, chemical settling device, anoxic biochemical treatment fluidized bed, anaerobic biochemical treatment fluidized bed and aerobic biochemical treatment fluidized bed are connected in sequence. The said primary filter device is composed of several filter modules. The said chemical settling device is composed of several chemical settling units. The said anoxic biochemical treatment fluidized bed unit is equipped with several anoxic biochemical treatment modules. The said anaerobic biochemical treatment fluidized bed is equipped with several anaerobic biochemical treatment modules. The said aerobic biochemical treatment fluidized bed is equipped with several aerobic biochemical treatment modules.

The said chemical settling units use the sloping plate settling tank where a sloping plate settling area is set, and drug administration space with a stirrer is located in front of the sloping plate settling area, and drug administration apparatus and its matching drug administration hole are located above the drug administration space. Drug administration apparatus put flocculant into the drug administration space continually according to the water flow. The flocculant is mixed sufficiently into the sewage by the stirring of the stirrer and flocculates with organic particulate matters and other organic molecules in the sewage, and then the sewage flows into the sloping plate settling area for settlement. The settling tank has high settling efficiency and small volume. Moreover, by adding flocculant, about more than 30% BOD and COD in the high concentration sewage are removed, which relieves the pollution loading of subsequent biochemical treatment and is especially suitable for the high concentration organic sewage.

Primary filter device 12 can be installed in front of the chemical settling device. The primary filter device, mainly filtering solids with large volume in the sewage, is composed of several filter modules. The filter modules are designed standardizedly to get optimal separating effect. When the treated sewage quantity is changing, the filter modules can be connected parallelly according to the need to assure filtration effect and resistance requirement. The said filter modules can use filter screen structure, the said filter screen is fixed on the framework of filter screen. Multiple frameworks of filter screen are installed parallelly on the primary filter device to form effective filtering surface.

Since main pollutants of high concentration organic sewage are BOD and COD, anoxic/anaerobic/aerobic combined treatment manner, which has good treatment effect and is suitable for advanced treatment of high concentration sewage, is used to assure purification effect of sewage, and to make the sewage meet the demand of inflow quality of the treatment system of low concentration organic sewage or reach the reclaimed water reuse standard directly. The biochemical reaction device, which is economical and effective, is suitable for China's national condition and can solve the problem of BOD/COD. Circulating fluidized bed is employed to reducing the land occupation, whose occupied area is very small (square meter order of magnitude) and treatment capacity per unit volume is far more than that of general sewage treatment equipment, and the retention time of sewage is relatively short. All of anoxic fluidized bed, anaerobic fluidized bed and aerobic fluidized bed employ modularization design, which are composed of several anoxic biochemical treatment modules, several anaerobic biochemical treatment modules and several aerobic biochemical treatment modules, respectively. Every module includes a framework or tank, corresponding filler or filtration membrane fixed by the framework or tank. Hydraulic retention time of sewage is determined according to the treatment capacity and concentration of sewage, then the needed modules are calculated under certain water volume, and the modules are installed on the fluidized bed. Process parameters of every fluidized bed such as temperature and oxygen content are controlled and adjusted by matched fan and heater, and several corresponding sensors and central control systems are employed to achieve real-time monitoring of these process parameters.

The outlet piping of every said fluidized bed is equipped with a three-way shunting valve 8. The shunting valve has two outlets and can adjust the effluent proportion of each outlet. One outlet connects with subsequent pipe (the subsequent pipe of anoxic fluidized bed is the inlet pipe of anaerobic fluidized bed, the subsequent pipe of anaerobic fluidized bed is the inlet pipe of aerobic fluidized bed, and the subsequent pipe of aerobic fluidized bed is the inlet pipe of subsequent settling tank or other treatment equipment), and the other outlet connects with the water inlet of fluidized bed itself to reflux and achieve multiple cycling treatments, so as to improve treating efficiency when necessary. The shunting valve is designed to adjust reflux rate conveniently and flexible for use.

A settling tank 5 is connected to the said aerobic biochemical treatment fluidized bed to settle the sludge produced by aerobic treatment. According to the requirement, sludge reflux pipeline can be employed to connect the sludge reflux outlet of settling tank and the inlet of aerobic fluidized bed for the reflux of sludge.

A sterilization device 6 is set after the settling tank and composed of several sterilization modules. Every sterilization module can use ozone sterilization module, electrolytic metal ion sterilization module or chemical sterilization module according to the need. The realization of modularization of sterilization device can also realize standardization design of sterilization modules. According to the need, the sterilization device can be equipped with a certain amount of sterilization modules.

A smashing device 12 is equipped in front of the primary filter device so as to smash impurities in the sewage, making the sewage suitable for subsequent treatment requirements.

The said anoxic biochemical treatment fluidized bed, anaerobic biochemical treatment fluidized bed, aerobic biochemical treatment fluidized bed, settling tank and sterilization device all have sewage outlets. Every said sewage outlet connects to the sludge pool 10 through sludge pipe 9 for centralized treatment.

The said parts connects with each other through sewage pipes 11, and can be equipped with corresponding pumps respectively to provide power for the flow of sewage and sludge.

A reclaimed water reservoir 7 is set after the settling tank or sterilization device of the present system to collect the discharged water after treatment for making use of the reclaimed water.

The system of present invention is an equipment-type rather than civil engineering-type system, that is every part using steel structure frame or shell, only the foundation being civil constructed. Therefore there is a little civil engineering quantity, and it is convenient for construction. The modularization design can make every module designed standardly and reaching its optimal structure and optimal operation environment to achieve ideal effect. Once the modules having been designed, the workload of specific engineering design is very small, only needing to calculate purification efficiency and module quantities of every part according to both quantity and inward-and-outward concentration of sewage, which is greatly convenient for practical extension and utilization

The advantages of the present system are as follows:

(1) the system can treat high concentration organic sewage effectively which is difficult for existing technology to deal with, and can match with the treatment system of low concentration organic sewage to make the sewage to be useful reclaimed water for treatment and use locally, reducing land occupation of sewage treating pipeline dramatically and solving the problem of treating sewage of small scale sewage source. This mode is complementary with traditional centralized treatment system characterized by civil engineering-type, employing discrete and compact type treatment system characterized by equipment-type according to local conditions to treat the dispersed pollution source locally without adding expensive centralized water treatment plant, therefore saving a lot of expenditure and land resources, and treating new coming pollution source in time;

(2) for its advantages of flexibility for setup, high efficiency, strong pertinence and updating, investment saving and small land occupation, etc., the system can treat the sewage classifiedly at local places to achieve regeneration, classification and recycling use of water. The multiple use of water improves water utilization and reduces pollution discharge;

(3) the system can provide a large amount of circulating water for production enterprises, and also economical circulating water system for residential areas, swimming pools, hot spring pools, landscape water, automobile cleaning, fisheries and many other places, to reduce water supplement and sewage discharge greatly in these areas. Compared with other treatment scheme, the cheap equipment expense can save a lot of funds, and is more acceptable to factories who produce pollution, therefore these factories can treat the pollution produced by themselves economically and efficiently;

(4) in the towns and remote areas where it is lack of the condition to set up large-scale sewage treatment plant, proper combination can be introduced according to local conditions to form sewage treatment equipments suitable for local conditions. It can increase water resources for use, and also be applied to river and lake purification, sewage and ditch purification, organic sewage treatment and feces and urine treatment in livestock farms, etc.

(5) the system helps to change the existing environmental protection engineering model designed and constructed respectively according to specific projects to form a new type environmental protection industry and bring environmental protection and economic benefits.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A treatment system of high concentration organic sewage, wherein the system mainly comprises a primary filter device, a chemical settling device, an anoxic biochemical treatment fluidized bed, an anaerobic biochemical treatment fluidized bed and an aerobic biochemical treatment fluidized bed; the said primary filter device, chemical settling device, anoxic biochemical treatment fluidized bed, anaerobic biochemical treatment fluidized bed and aerobic biochemical treatment fluidized bed are connected in sequence; the said primary filter device is composed of several filter modules; the said chemical settling device is composed of several chemical settling units; the said anoxic biochemical treatment fluidized bed unit is equipped with several anoxic biochemical treatment modules; the said anaerobic biochemical treatment fluidized bed is equipped with several anaerobic biochemical treatment modules, and the said aerobic biochemical treatment fluidized bed is equipped with several aerobic biochemical treatment modules.

2. The treatment system of high concentration organic sewage according to claim 1, wherein the said primary filter device is installed in front of the chemical settling device; the said primary filter device is composed of several filter modules; the said filter modules use filter screen structure designed standardly; the said filter screen is fixed on the framework of filter screen; multiple frameworks of filter screen are installed parallelly on the primary filter device to form effective filtering surface.

3. The treatment system of high concentration organic sewage according to claim 2, wherein the outlet piping of every said fluidized bed is equipped with a three-way shunting valve; the shunting valve has two outlets and can adjust the effluent proportion of each outlet, one outlet connecting with subsequent pipe and the other outlet connecting with the water inlet of fluidized bed itself.

4. The treatment system of high concentration organic sewage according to claim 3, wherein a settling tank is connected to the said aerobic biochemical treatment fluidized bed, and sludge reflux pipeline is employed to connect sludge reflux outlet of settling tank and inlet of aerobic fluidized bed.

5. The treatment system of high concentration organic sewage according to claim 4, wherein a sterilization device is set after the said settling tank and composed of several sterilization modules; every sterilization module uses ozone sterilization module, electrolytic metal ion sterilization module or chemical sterilization module.

6. The treatment system of high concentration organic sewage according to claim 5, wherein a smashing device is equipped in front of the said primary filter device.

7. The treatment system of high concentration organic sewage according to claim 6, wherein the said anoxic biochemical treatment fluidized bed, anaerobic biochemical treatment fluidized bed, aerobic biochemical treatment fluidized bed, settling tank and sterilization device all have sewage outlets; every said sewage outlet connects to the sludge pool through sewage pipe.

8. The treatment system of high concentration organic sewage according to claim 7, wherein the said parts connect with each other through sewage pipes, and are equipped with corresponding pumps respectively.

9. The treatment system of high concentration organic sewage according to claim 8, wherein a reclaimed water reservoir is set after the said settling tank or sterilization device.

10. The treatment system of high concentration organic sewage according to claim 1, wherein several corresponding sensors and central control systems are employed to real-timely monitor the process parameters.

11. The treatment system of high concentration organic sewage according to claim 10, wherein the primary filter device is installed in front of the chemical settling device; the said primary filter device is composed of several filter modules; the said filter modules use filter screen structure designed standardly; the said filter screen is fixed on the framework of filter screen; multiple frameworks of filter screen are installed parallelly on the primary filter device to form effective filtering surface.

12. The treatment system of high concentration organic sewage according to claim 11, wherein the outlet piping of every said fluidized bed is equipped with a three-way shunting valve; the shunting valve has two outlets and can adjust the effluent proportion of each outlet, one outlet connecting with subsequent pipe and the other outlet connecting with the water inlet of fluidized bed itself.

13. The treatment system of high concentration organic sewage according to claim 12, wherein a settling tank is connected to the said aerobic biochemical treatment fluidized bed, and sludge reflux pipeline is employed to connect sludge reflux outlet of settling tank and inlet of aerobic fluidized bed.

14. The treatment system of high concentration organic sewage according to claim 13, wherein a sterilization device is set after the said settling tank and composed of several sterilization modules; every sterilization module uses ozone sterilization module, electrolytic metal ion sterilization module or chemical sterilization module.

15. The treatment system of high concentration organic sewage according to claim 14, wherein a smashing device is equipped in front of the said primary filter device.

16. The treatment system of high concentration organic sewage according to claim 15, wherein the said anoxic biochemical treatment fluidized bed, anaerobic biochemical treatment fluidized bed, aerobic biochemical treatment fluidized bed, settling tank and sterilization device all have sewage outlets; every said sewage outlet connects to the sludge pool through sewage pipe.

17. The treatment system of high concentration organic sewage according to claim 16, wherein the said parts connect with each other through sewage pipes, and are equipped with corresponding pumps respectively.

18. The treatment system of high concentration organic sewage according to claim 17, wherein a reclaimed water reservoir is set after the said settling tank or sterilization device.
